(19) United States
(12) Patent Application Publication
(10) Pub. No.: US 2012/0308866 A1
(43) Pub. Date: Dec. 6, 2012

(54) CONNECTION STRUCTURE

(75) Inventors: Ryuhei Nishida, Yokohama-shi (JP); Tadahide Shiomoto, West Bloomfield, MI (US)

(73) Assignee: NIFCO INC., Yokohama-shi, Kanagawa (JP)

(21) Appl. No.: 13/516,903

(22) PCT Filed: Dec. 22, 2010
(86) PCT No.: PCT/JP2010/073179

§ 371 Date: Jul. 27, 2012

(30) Foreign Application Priority Data
Dec. 24, 2009 (JP) 2009-292022

(51) Int. Cl. H01M 2/10

(52) U.S. Cl. 429/100

(57) ABSTRACT

The invention is a structure for connecting modules housing electrical storage cells to construct an electrical storage system. The structure has a pair of clips having a first coupling part for coupling with the other clip of the pair and a second coupling part for coupling with a case of a module. From a state in which the first coupling parts couple the pair of clips, adjacent modules are connected by coupling the second coupling parts of the pair of clips to the respectively corresponding cases, and the coupling of the first coupling parts is released when the connected modules are subjected to a separation operation with a prescribed force.

### TECHNOLOGICAL FIELD

This invention relates to a connection structure for connecting modules configuring an electrical storage system of a hybrid car, electric automobile, or the like.

### BACKGROUND TECHNOLOGY

An electrical storage system of a hybrid car, electric automobile, or the like, is configured with a set of modules housing electrical storage cells. The assembled modules are finally fastened by running bolts, or the like, through the respective modules, but it is required that adjacent modules be connected together in advance of the final fastening.

Patent document 1 illustrates an example in which frame bodies (modules) housing electrical storage cells are connected by fitting insertion-coupling projecting parts on each frame body into insertion-coupling recessed parts. Patent document 2 illustrates an example in which a spacer is interposed between each module to provide clearance, but connecting the modules together in advance of the final fastening is not considered.

### PRIOR ART DOCUMENTS

### Patent Documents

Patent Document 1: Japanese Patent Publication No. 2005-268004
Patent Document 2: Japanese Patent Publication No. 2006-147531

### SUMMARY OF THE INVENTION

### Problem to Be Solved by the Invention

A main problem to be solved by this invention is, firstly, to make it possible to connect this kind of modules together easily and adequately in advance of final fastening, and secondly, to make it possible also to release this connection easily without causing deformation or damage on the module side.

### Means for Solving the Problem

In order to solve the aforementioned problem, in this invention, a connection structure is made by connecting modules housing electrical storage cells to configure an electrical storage system and includes a pair of clips having a first coupling part for coupling with the other clip of the pair and a second coupling part for coupling with a case of a module.

From a state in which the pair of clips is coupled with the first coupling parts, the second coupling parts of the pair of clips are coupled to the respectively corresponding cases for connecting the modules adjacent to each other.

The coupling of the first coupling parts is released when the connected modules are subjected to a separation operation with a prescribed force.

According to such connection structure, adjacent modules can be connected together using a pair of clips combined by coupling the first coupling parts. Also, this connected state can be released easily by subjecting the modules to the separation operation. By this, replacement, or the like, of one portion of modules configuring the electrical storage system can be performed easily. Also, given that the case of this kind of module is thin and brittle, deformation or damage to the case side of the modules can be prevented to the extent possible when releasing the connection between the modules, by arranging so that the coupling of the first coupling parts is released first by the separation operation.

One favorable aspect is one in which: each of the second coupling parts of such a pair of clips is formed on a leg part to be inserted in an installation hole on the case; and each of the pair of clips is rotated in a releasing direction of the coupling of the first coupling parts centered on the leg part when the connected modules are subjected to a separation operation with a prescribed force. In this case, it is further preferable that: such a pair of clips is coupled overlaying the first coupling part of one clip and the first coupling part of the other clip in a direction of an axis of rotation of the clips; and each of the pair of clips has urging means capable of urging the other clip in a direction of maintaining this overlaying. Also, in this case, it is further preferable that: each of the first coupling parts of such a pair of clips has an inclined surface oriented toward the side of the second coupling part, and the inclined surfaces are placed contacting with each other in the coupled state.

In such case, the adjacent modules can be connected adequately by coupling of the first coupling parts, and at the same time, the place of formation of the first coupling parts interposed between the adjacent modules can be constituted as thinly as possible. Also, the coupling strength between the first coupling parts of the pair of clips, that is, the strength of connection between the adjacent modules, can be adjusted easily by changing the urging force of the urging means. Also, the respective clips can be rotated smoothly in the releasing direction of the coupling of the first coupling parts using the inclined surfaces contacting with each other, by the separation operation.

It may be possible that: extending parts extending from a center of rotation side of the clip are formed in two regions facing each other of four regions, which are divided by a virtual first line passing through the center of rotation and a virtual second line intersecting with the first line at this center of rotation;

the first coupling parts are formed respectively on edge parts along the first line on the two extending parts;

an elastic piece as urging means is protruding from an edge part along the second line on one of the two extending parts; and

an edge part following the second line on the other of the two extending parts is used as a contacted part for contacting with the elastic piece of the other clip of the pair.

In such case, the side of formation of the first coupling part of one of the pair of clips and the side of formation of the first coupling part of the other are abutted together, and the elastic piece is placed contacting with the contacted part and is elastically deformed while the first coupling part of one clip enters beneath the first coupling part of the other clip, and thereafter the deformation of the elastic piece is released, whereby the respective clips are rotated to some extent and can be coupled inserting each first coupling part beneath the corresponding first coupling part. That is, in such case, the connection structure can be configured by combining two clips having the same size and same shape.

It may be possible that the first coupling parts of the pair of clips are coupled, sandwiching a spacer interposed between adjacent modules. In this case, it is further preferable that each of the pair of clips has a clipping part further outside from a place of formation of first coupling parts coupled together through a through-hole on the spacer.

In such case, adjacent modules can be connected in a state having a spacer interposed, by installing the pair of clips on the spacer such that the spacer is sandwiched between the clips, and from that state inserting the leg part in the corresponding installation hole of the module whereby coupling is performed on the module side using the second coupling part formed on the leg part.

### Effect of the Invention

According to this invention, modules configuring an electrical storage system can be connected together easily and adequately in advance of final fastening. Also, because the paired clips having the first coupling parts coupled together are separated by subjecting the connected modules to a separation operation so that the modules can be separated, the release of this connection also can be performed without causing deformation or damage to the module side.

### BRIEF DESCRIPTION OF THE DRAWINGS

FIG. 1 is a perspective view illustrating adjacent modules and spacers with clips attached in a separated state.

FIG. 2 is a sectional view of essential parts of the connection structure.

FIGS. 3(a) and 3(b) are perspective views of a pair of clips in which the first coupling parts are not coupled, wherein FIG. 3(b) illustrates such a pair of clips being viewed from a different direction than in FIG. 3(a).

FIGS. 4(a) and 4(b) are perspective views, omitting depiction of the spacers, of a pair of clips in which the first coupling parts are coupled, wherein FIG. 4(b) illustrates such a pair of clips being viewed from a different direction than in FIG. 4(a).

FIG. 5 is a perspective view, omitting depiction of the spacers, of a pair of clips in which the first coupling parts are coupled.

FIG. 6 is a perspective view, omitting depiction of the spacers, illustrating a pair of clips having been rotated to some extent in the releasing direction of the coupling of the first coupling parts by performing a separation operation on modules connected together by the a pair of clips.

FIG. 7 is a plan view of the clip.

FIG. 8 is a bottom view of the clip.

FIG. 9 is a side view of the clip.

FIG. 10 is a side view of the clip viewed from a different direction than FIG. 9.

FIG. 11 is a sectional view along the line A-A in FIG.

FIG. 12 is a sectional view along the line B-B in FIG. 7.

### EMBODIMENTS OF THE INVENTION

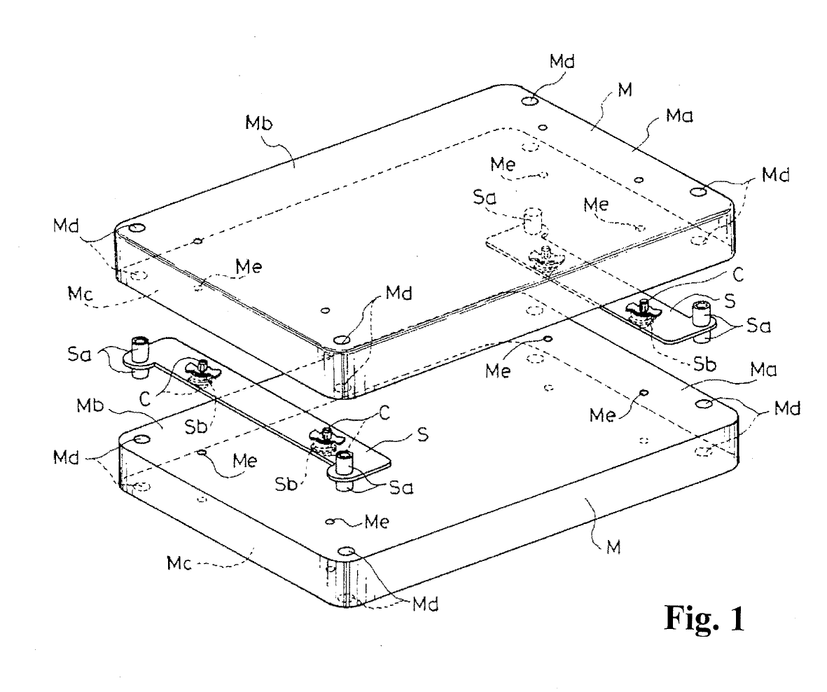

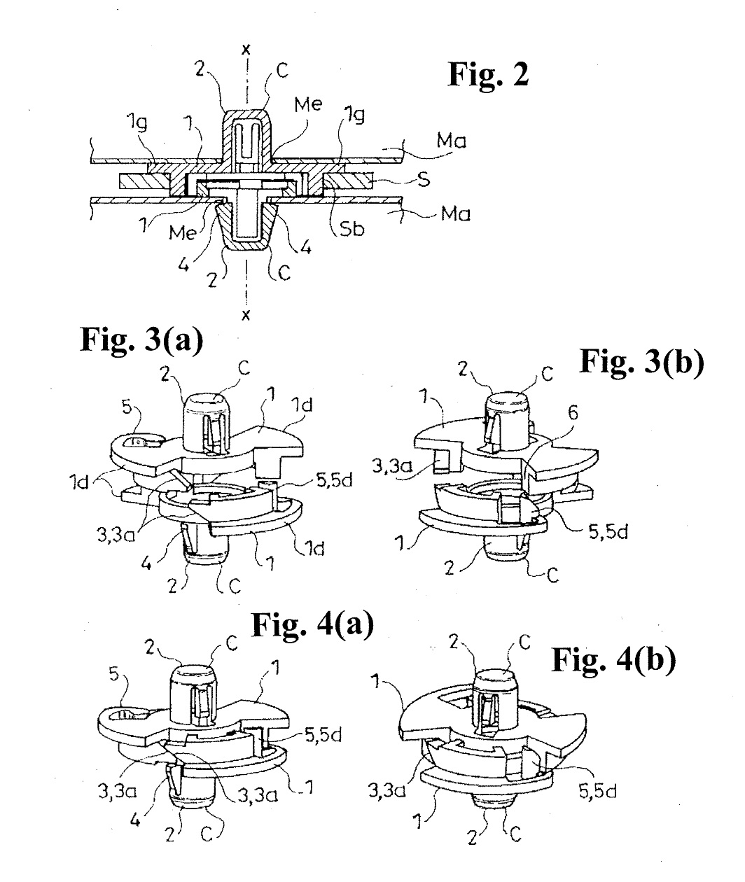

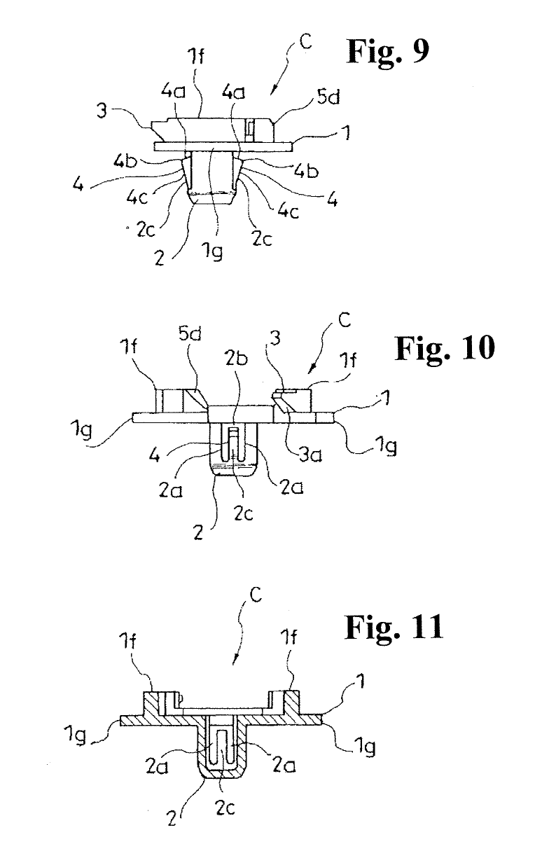

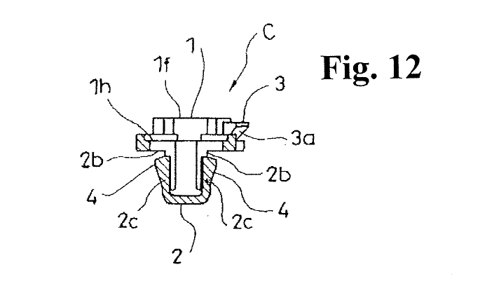

A typical embodiment of this invention is described below based on FIGS. 1 to 12. The connection structure according to this embodiment is used for connecting modules M (also referred to as “electrical storage modules,” or the like) configuring an electrical storage system (also referred to as “electrical storage unit,” or the like) of a hybrid car, electric automobile, or the like. Such electrical storage system is configured by connecting a plurality of such modules M. More specifically, said electrical storage system is configured with a plurality of modules M, M, . . . by connecting adjacent modules M and M together using the present connection structure. Each module M is configured housing an electrical storage cell, not illustrated, in a case Ma.

In the illustrated example, the module M has a configuration in which an electrical storage cell is housed inside a flat case Ma having a broad front face Mb and back face Mc in roughly rectangular form. Large-diameter round holes Md are formed in the four corners respectively on the front face Mb and back face Mc of the case Ma, and installation holes Me having a smaller diameter are punched somewhat inward from the positions of formation of the respective round holes Md.

In the illustrated example, adjacent modules M and M are connected in a vertically overlaid manner or in a parallel manner left to right, in a state in which the broad faces Mb and Mc of the cases Ma are placed facing each other and the sides of the broad faces Mb and Mc are lined up. A spacer S is interposed between adjacent modules M and M. In the illustrated example, such spacer S is constituted as a long and slender board form having a length to be contained within the width of the broad faces Mb and Mc of the case Ma. One face of the spacer S is placed contacting with one of the adjacent modules M and M, and the other face is placed contacting with the other of the adjacent modules M and M, whereby a gap in the amount of the thickness of such spacer S is formed between the adjacent modules M and M. Hollow boss parts Sa projecting in directions orthogonal to the board face of the spacer S are formed on both faces of the spacer S respectively on both end parts of the spacer S. In the illustrated example, the spacers S are placed on both short sides of the module M, inserting the boss parts Sa into the round holes Md in two places respectively on these short sides. The boss parts Sa on one face side of the spacer S are inserted into the round holes Md of one of the adjacent modules M and M, and the boss parts Sa on the other face side of the spacer S are inserted into the round holes Md on the other of the adjacent modules M and M. A plurality of modules M, M, . . . thus connected is fully fastened by bolts, not illustrated, passed through the round holes Md of the modules M and the boss parts Sa of each spacer S.

In this embodiment, the adjacent modules M and M are connected together by a pair of clips C and C in advance of the full fastening. Such a pair of clips C and C couple first coupling parts 3, to be described, sandwiching the spacer S interposed between the adjacent modules M and M. Each of such pair of clips C and C has a leg part 2 to be inserted into the installation hole Me of the module M on the side opposite to that of the first coupling part 3, and the adjacent modules M and M are connected in a state having the spacer S interposed, by installing the clips on the spacer S, and from that state inserting such leg part 2 in the corresponding installation hole Me of the module M whereby coupling is performed on the module M side using a second coupling part 4, to be described, formed on the leg part 2.

Specifically, a through-hole Sb accommodating the place of formation of the first coupling part 3 of the clip C is formed between a pair of boss parts Sa and Sa on the spacer S, and each of the pair of clips C and C clips the spacer S, coupling the first coupling parts 3 together inside this through-hole Sb. Specifically, a clipping part 1g not fitting inside the through-hole Sb is formed further outside from the position of formation of this first coupling part 3 on the clip C, and the clipping of the spacer S is performed between such clipping parts 1g of the pair of clips C and C.

The pair of clips C and C has a first coupling part 3 for coupling with the other clip C of the pair and a second coupling part 4 for coupling with a case Ma of a module M. Also, adjacent modules M and M are connected by coupling the pair of clips C and C using the first coupling parts 3, and from that state coupling the second coupling parts 4 of this pair of clips C and C to the respectively corresponding cases Ma. In addition, the coupling of the first coupling parts 3 is released when the connected modules M are subjected to a separation operation with a prescribed force.

By this, according to the connection structure according to this embodiment, adjacent modules M and M can be connected together using a pair of clips C and C combined by coupling the first coupling parts 3. Also, this connected state can be released easily by subjecting the modules M to the separation operation. By this, replacement, or the like, of one portion of modules M configuring the electrical storage system can be performed easily. Also, given that the case Ma of this kind of module M is thin and brittle, deformation or damage to the case Ma side of the modules M can be prevented to the extent possible when releasing the connection between the modules M, by arranging so that the coupling of the first coupling parts 3 is released first by the separation operation.

Each of the second coupling parts 4 of such a pair of clips C and C is formed on a leg part 2 to be inserted in an installation hole Me on the case Ma. Also, each of the pair of clips C and C is rotated in a direction of releasing the coupling of the first coupling parts 3 centered on the leg part 2, in other words, with the installation hole Me as a shaft bearing, when the connected modules M are subjected to a separation operation with a prescribed force.

More specifically, such a pair of clips C and C is coupled overlaying the first coupling part 3 of one clip and the first coupling part 3 of the other clip in a direction of an axis of rotation of the clips (coincides with the center axis x of the leg part 2), and each of the pair of clips C and C has urging means 5 capable of urging the other clip C in a direction of maintaining this overlaying. Also, each of the first coupling parts 3 of such a pair of clips C and C has an inclined surface 3a oriented toward the side of the second coupling part 4, and the inclined surfaces 3a are placed contacting with each other in the coupled state.

By this, in the connection structure according to this embodiment, the adjacent modules M and M can be connected adequately by coupling of the first coupling parts 3, and at the same time, the place of formation of the first coupling parts 3 interposed between the adjacent modules M and M can be constituted as thinly as possible. Also, the coupling strength between the first coupling parts 3 of the pair of clips C and C, that is, the strength of connection between the adjacent modules M and M, can be adjusted easily by changing the urging force of the urging means 5. Also, the respective clips C can be rotated smoothly in the direction of releasing the coupling of the first coupling parts 3 using the inclined surfaces 3a being in contact with each other, by the separation operation.

In this embodiment, the pair of clips C and C is configured with the same size and same shape. Such Clip C has a head part 1 having a thickness to fit inside the gap between adjacent modules M and M, that is, the thickness of the spacer S, and the leg part 2. Also, the first coupling part 3 and the urging means 5 are provided on this head part 1, and the second coupling means are provided on the leg part 2.

The leg part 2 is constituted as a shaft form projecting in a direction orthogonal to a back face 1b of the head part 1 with one end being integrally connected to this back face 1b in the center of this head part 1. The leg part 2 has a width to be capable insertion into the installation hole Me, and the head part 1 has a size not fitting into this installation hole Me. The head part 1 has a board form in general, and is formed such that the board surface is arranged in a direction orthogonal to the center axis x of the leg part 2. In the illustrated example, the leg part 2 is constituted as a cylindrical body having the other end closed. The second coupling parts 4 are formed respectively in opposite positions with the center axis x of the leg part 2 in between. Each second coupling part 4 is constituted by forming an exposed part on an outer face part of an elastic piece 2c divided by two slits 2a and 2a following the center axis x of the leg part 2 and a slit 2b in a direction orthogonal to this center axis x spanning between the slit ends on the head part 1 side of these two slits 2a and 2a. Such second coupling part 4 has a coupling facing the side of the head part 1, and has a space between a base part of the elastic piece 2c and a vertex part 4b of the second coupling part 4 formed as an inclined surface 4c. The distance between the vertex parts 4b of the pair of second coupling parts 4 and 4 is somewhat larger than the hole diameter of the installation hole Me. Also, the distance between the coupling surface 4a and the back face 1b of the head part 1 is about the same as or somewhat larger than the thickness of the case Ma of the module M. By this, in this embodiment, insertion of the leg part 2 of the clip C into the installation hole Me of the case Ma of the module M from outside of this case Ma is allowed by flexing in of the elastic piece 2c accompanying sliding contact of the inclined surface 4c on the side of this installation hole Me, and the case Ma is sandwiched from the inside between the second coupling part 4 and the head part 1, by flexing back of the elastic piece 2c at a final position of insertion where the vertex part 4b of the second coupling part 4 has entered further forward from the hole edge of the installation hole Me on the inside of the case Ma, such that the clip C is coupled with the module M. Because the clip C is coupled with the module M by such flexing in and flexing back, there is resistance for insertion of the leg part 2 into the installation hole Me until the flexing back, and because the coupling is accomplished at the time when this resistance disappears, the status of this coupling can be clearly recognized by the operator.

The head part 1 has a center part 1c formed inside a virtual first circle (not illustrated), and extending parts 1d formed on both sides in the diameter direction of this center part 1c. An outer edge 1e of the extending part 1d follows an arc of a virtual second circle r having a larger diameter than the first circle. Also, a rib 1f following an arc of a virtual third circle r′ having a larger diameter than the first circle and having a diameter smaller than the second circle r is formed on an upper face part of the extending part 1d constituting the upper face 1a of the head part 1. This virtual third circle r′ is approximately equal to the hole size of the through-hole Sb of the spacer S, and is such that a place including this rib 1f and further inside thereof of the head part 1 can be inserted inside such through-hole Sb. A space between the rib if and the outer edge 1e on this extending part 1d serves as the clipping part 1g. A long hole 1h is formed on the center part 1c, and this long hole 1h connects through at the center thereof to the inside of the leg part 2.

The extending parts 1d are formed in two opposite regions of four regions divided by a virtual first line L passing through the center of rotation of the clip C, that is, the center of the center part 1c, and a virtual second line L′ intersecting with the first line L at this center of rotation, so as to extend from side of the center of rotation, that is, the center part 1c.

Also: the first coupling parts 3 are formed respectively on edge parts 1i following the first line L on the two extending parts 1d;

an elastic piece 5a as urging means 5 is placed protruding from an edge part 1j following the second line L′ on one of the two extending parts 1d; and

an edge part 1j following the second line L′ on the other of the two extending parts 1d serves as a contacted part 6 for contacting with the elastic piece 5a of the other clip C of the pair.

In the illustrated example, such first coupling part 3 is constituted as a claw form projecting from the edge part 1i so as to follow the arc of the virtual third circle r′. Also, this first coupling part 3 continues on the rib 1f. The first coupling part 3 has an upper face part, serving as one portion of the upper face 1a of the head part 1, as a face orthogonal to the center axis x of the leg part 2, and a face on the side opposite this [upper face part] as the inclined surface 3a, and is constituted such that the thickness dimension thereof is reduced going toward the projecting end thereof.

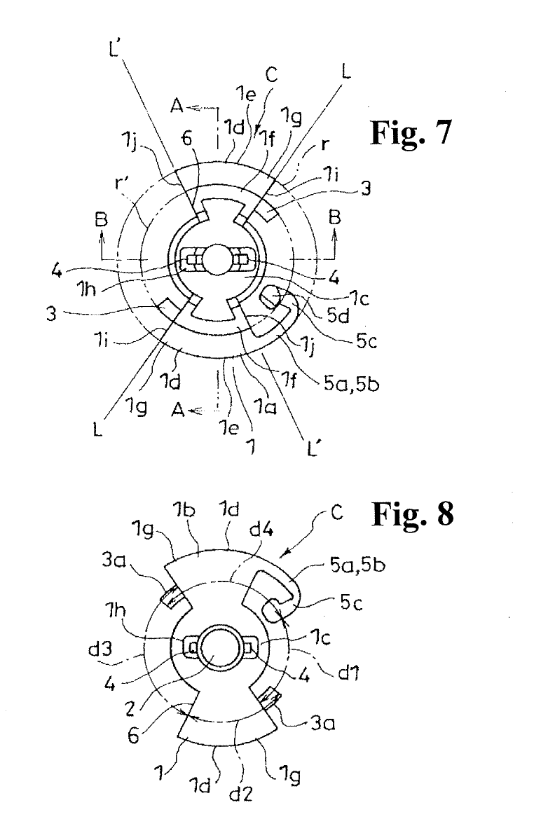

Also, the elastic piece 5a has an outside arm part 5b projecting from the edge part 1j following the arc of the virtual second circle r, an inside arm part 5c extending to the side of the center part 1c forming a bent part in the space between together with the end part of this outside arm part 5b, and a rod-form contact part 5d projecting in the direction following the center axis x from the upper face part of the end part of the inside arm part 5c. Also, the elastic piece 5a has an upper face part constituting the upper face 1a of the head part 1, and a lower face part constituting the lower face 1b. Also, in this embodiment, a distance d1 between the rod-form contact part 5d of such elastic piece 5a and the edge part 1i where the first coupling part 3 is formed on the extending part 1d where this elastic piece 5a is not provided is approximately congruent with a distance d2 between the projecting end of the first coupling part 3 on the extending part 1d where this elastic piece 5a is not provided and the contacted part 6. Also, a distance d3 between the contacted part 6 on the extending part 1d where the elastic piece 5a is not provided and the edge part 1i where the first coupling part 3 is formed on the extending part 1d where the elastic piece 5a is provided is approximately congruent with a distance d4 between the rod-form contact part 5d of the elastic piece 5a and the projecting end of the first coupling part 3 on the extending part 1d where this elastic piece 5a is provided (FIG. 8).

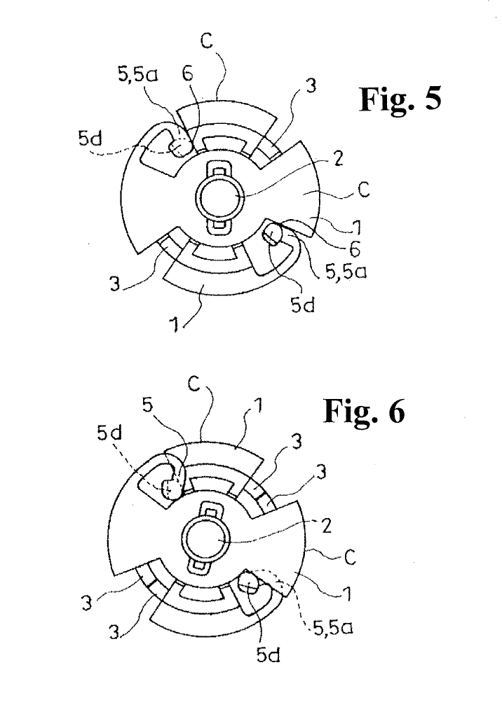

By this, in this embodiment, the side of formation of the first coupling part 3 of one of the pair of clips C and C and the side of formation of the first coupling part 3 of the other are abutted together, and the elastic piece 5a is placed in contact with the contacted part 6 and is elastically deformed while the first coupling part 3 of one clip C enters beneath the first coupling part 3 of the other clip C, and thereafter the deformation of the elastic piece 5a is released, whereby the respective C clips are rotated to some extent C and can be coupled inserting each first coupling part 3 beneath the corresponding first coupling part 3 (FIGS. 4(a) and (b) and FIG. 5). That is, in this embodiment, the connection structure can be configured by combining two clips C having the same size and same shape.

When the separation operation is performed from a state in which the adjacent modules M and M are connected by such clips C (FIG. 5), the respective clips C rotate in a direction of releasing the coupling of the first coupling parts 3 while the elastic pieces 5a are elastically deformed by the inclined surfaces 3a being in contact with the first coupling parts 3 (FIG. 6). Specifically, when this separation operation is performed, each clip C rotates in the opposite direction to that of the other clip with the base part of the leg part 2 inside the installation hole Me as the shaft and the installation hole Me as the shaft bearing. When the clips C are rotated up to a position of rotation where the first coupling part 3 of one of the two clips C escapes from beneath the first coupling part 3 of the other, the coupling of the first coupling parts 3 is released, and the two clips C are separated in a state in which the second coupling parts 4 are coupled with the respective modules M.

The entire contents of the specification, claims, drawings, and abstract of Japanese Patent Application No. 2009-292022 filed on Dec. 24, 2009 are incorporated by reference herein as a disclosure of the specification of the present invention.

1. A connection structure for connecting modules housing electrical storage cells adapted to construct an electrical storage system, comprising:
a pair of clips having a first coupling part for coupling one clip of the pair of clips with the other clip of the pair of clips and a second coupling part for coupling with a case of the module;
wherein from a state in which the pair of clips is coupled with the first coupling parts, the second coupling parts of the pair of clips are coupled to the respective corresponding cases for connecting the modules adjacent to each other; and
coupling of the first coupling parts is released when the connected modules are subjected to a releasing operation with a predetermined force.

2. A connection structure according to claim 1, wherein each of the second coupling parts of the pair of clips is formed on a leg part adapted to be inserted in an installation hole on the case; and
each of the pair of clips is rotated in a releasing direction of the coupling of the first coupling parts around said leg part when the connected modules are subjected to the releasing operation with the predetermined force.

3. A connection structure according to claim 2, wherein the pair of clips is coupled by overlapping the first coupling part of one clip and the first coupling part of the other clip in a direction of an axis of rotation of the clips; and
each of the pair of clips has an urging device capable of urging the other clip in a direction of maintaining the overlapping.

4. A connection structure according to claim 3, wherein each of the first coupling parts of the pair of clips has an inclined surface facing a side of the second coupling part, and the inclined surfaces are contacting with each other in a coupled state.

5. A connection structure according to claim 3, wherein four regions are formed by dividing the connection structure into four by a virtual first line passing through a center of rotation and a virtual second line intersecting with said first line at the center of rotation, and extending parts extending from the center of rotation of the clip are formed in two regions facing each other of the four regions;
the first coupling parts are formed respectively on edge parts along said first line of the two extending parts;
an elastic piece as the urging device protrudes from an edge part along said second line on one of the two extending parts; and
the edge part along said second line on the other of the two extending parts is a contacted part to contact the elastic piece of the other clip of the pair.

6. A connection structure according to any of claim 1, wherein the pair of clips sandwiches a spacer interposed between the adjacent modules and couples the first coupling parts.

7. A connection structure according to any of claim 1, wherein each of the pair of clips has a holding part disposed on an outer side than a position of formation of the first coupling parts coupled together in a through-hole on the spacer.
